(19) United States
(12) Patent Application Publication
(10) Pub. No.: US 2018/0067991 A1
(43) Pub. Date: Mar. 8, 2018

(54) Using Structured Smart Digital Memory to Personalize Digital Agent and Bot Scenarios

(71) Applicant: Microsoft Technology Licensing, LLC, Redmond, WA (US)

(72) Inventors: Vipul Agarwal, Bellevue, WA (US); Ruhi Sarikaya, Redmond, WA (US)

(73) Assignee: Microsoft Technology Licensing, LLC, Redmond, WA (US)

(21) Appl. No.: 15/256,142

(22) Filed: Sep. 2, 2016

(51) Int. Cl. G06F 17/30; G06N 5/02

(52) U.S. Cl. CPC G06F 17/30477; G06N 5/02

(57) ABSTRACT

A system and method for personalizing a user's digital assistant. The digital assistant is accessed via the user's device and the user initiates a query via the digital assistant. The digital assistant then performs a search to provide a response to the user's query. A session is defined and stored linking the user's query with the digital assistant's response. A knowledge base is generated with information associated with a plurality of sessions. A shadow profiled may also be generated from which inferences may be generated. Information associated with prior sessions may be retrieved in response to subsequent queries from the user.

### BACKGROUND

A digital assistant (DA) is a software agent that performs tasks or services for a user interacting with a device. Typically, the tasks or services are based on user input and the user's location. For example, the user may query the digital assistant for a list of restaurants near the user's current location. The digital assistant can then access information from online resources to provide a list of restaurants in close proximity to the user. The user may then review the list, select one of the restaurants, or initiate another query.

However, the digital assistants today are personalized only with respect to the current state of the user, ie; it leverages user's current location, current time of day, calendar information etc, but the digital assistant does not have digital memory to remember past actions like user's queries, the results provided, or the online resources accessed in response to a particular query. In particular, the digital assistant does not remember how the user interacted in regard to the digital assistant's response to a query. What is needed is a way to structure and store information so that it may be accessed at a later time without having to subsequently reinitiate the same query and without requiring the user to repeat past interactions or remember the steps previously taken regarding the same or similar query results.

### SUMMARY

This summary is provided to introduce a selection of concepts in a simplified form that are further described below in the Detailed Description section. This summary is not intended to identify key features or essential features of the claimed subject matter, nor is it intended as an aid in determining the scope of the claimed subject matter.

According to one aspect disclosed herein, a method is presented for personalizing a user's digital assistant. The method disclosed herein includes accessing the digital assistant via a device, receiving a first input from the user via the digital assistant and performing a task via the digital assistant in response to the first input. The method also includes defining and storing a first session linking the first input from the user with the completed task performed via the digital assistant and generating a knowledge base of information associated with a plurality of sessions. The method may also include retrieving information about the first session from the knowledge base in response to subsequently receiving a second input from the user.

According to another aspect disclosed herein, a system is presented for enhancing a digital assistant. The system disclosed herein includes at least one processor and an operating environment executing using the at least one processor to perform actions including receiving a first input from the user via a digital assistant, performing a task via the digital assistant in response to the user input, defining and storing a session linking the first input from the user with the completed task performed via the digital assistant, and generating a knowledge base of information based on a plurality of sessions. The system may also perform actions including retrieving information about the session from the knowledge base in response to subsequently receiving a second input from the user referencing information associated with the session of the first input and generating a recommendation to the user based on information in the knowledge base.

According to yet another aspect disclosed herein, a computer-readable storage medium including instructions for enhancing a digital assistant on a user's device is disclosed. The instructions executed by a processor include accessing the digital assistant via a device, receiving a first query as input from the user via the digital assistant and, in response to the user's first query, generating search results via the digital assistant accessing an application on the device or accessing an online resource. The instructions also include defining and storing a session linking the first query from the user with the search results generated via the digital assistant, generating a knowledge base of information based on a plurality of sessions, and retrieving information about the session from the knowledge base in response to subsequently receiving a second query as input from the user, wherein the second query references the first query.

Examples are implemented as a computer process, a computing system, or as a computer program product for one or more computers. According to an aspect, the computer program product is a server of a computer system having a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates a networked-computing environment for accessing and utilizing a digital assistant;

FIG. 2 illustrates an alternative environment for accessing and utilizing a digital assistant;

FIG. 3 illustrates a system architecture and the general stages involved in enhancing a digital assistant according to at least one embodiment disclosed herein;

FIG. 4 illustrates a flowchart for enhancing a digital assistant according to at least one embodiment disclosed herein; and

FIGS. 5, 6A, 6B and 7 illustrate a variety of operating environments in which various embodiments may be practiced.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

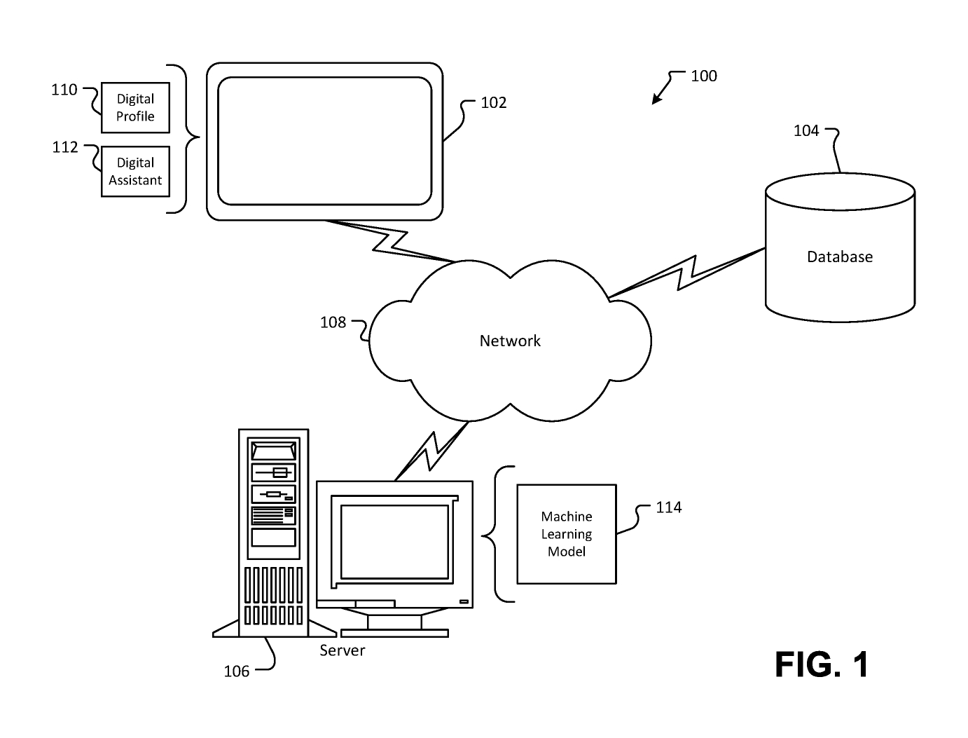

FIG. 1 illustrates a networked-computing environment 100 for using a computing device with a digital assistant. The environment 100 includes a computing device 102, a networked-database 104, and a server 106, each of which is communicatively coupled to each other via a network 108. The computing device 102 may be any suitable type of computing device. For example, the computing device 102 may be one of a desktop computer, a laptop computer, a tablet, a mobile telephone, a smart phone, a wearable computing device, or the like. Also, the computing device 102 may store a digital profile 110 and a digital assistant 112. The digital profile 110 is a set of information about a user. Multiple digital profiles 110 may be stored on the computing device 102 and each particular digital profile 110 corresponds to a particular user. The use of digital profile 110, in particular the use of a shadow profile, in combination with a digital assistant 112, is described in greater detail below.

System 100 may also have a database 104 for storing a variety of information. The network 108 facilitates communication between devices, such as computing device 102, database 104 and server 106. The network 108 may include the Internet and/or any other type of local or wide area networks. Communication between devices allows for the exchange of data and files such as answers to indirect questions, information associated with digital profiles, and other information.

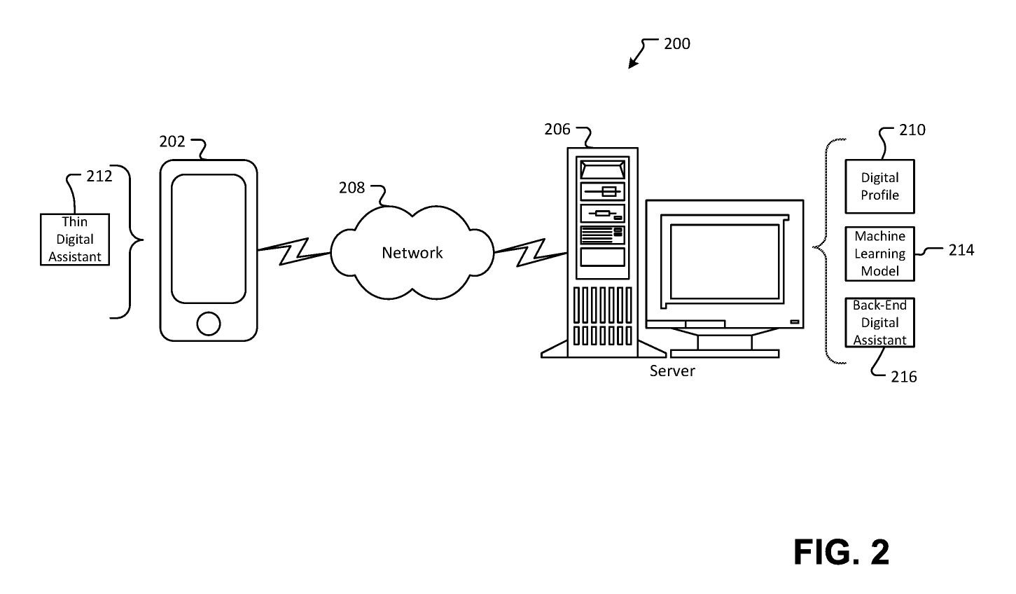

FIG. 2 illustrates an alternative environment 200 for using a computing device with a digital assistant. The networked environment 200 includes a computing device 202 and a server 206, each of which is communicatively coupled to each other via a network 208. It will be appreciated that the elements of FIG. 2 having the same or similar names and functions as those depicted in FIG. 1.

The digital assistant 112 of FIG. 1 may be located on the computing device 102 to receive input from the user, interpret the input, and then perform a task in response to the user's input or take other appropriate action as required. For example, the digital assistant 112 may respond to a query from the user of the computing device 102. Such queries may be entered into the computing device 102 in a variety of ways including text, voice, gesture, and/or touch. For example, a user may query the digital assistant 112 using a voice query or a voice command. The digital assistant 112 interprets the input and responds accordingly. More particularly, the user may query the digital assistant with a voice query and the digital assistant then provides an audible or visual response to the voice query. The voice query together with the response defines a conversation between the user and the digital assistant.

The digital assistant 212 of FIG. 2 is stored on a computing device 202. The digital assistant 202 may be a thin digital assistant 202, where the thin digital assistant 202 is configured to display audio and visual messages and receive input. The input may be sent via the network 208 to the server 206, and some or all of the processing of received queries is completed by the back end digital assistant 216. The back end digital assistant 216 works with the digital assistant 212 to provide the same or similar user experience as the digital assistant 112 described with reference to FIG. 1.

While FIGS. 1 and 2 illustrate systems in particular configurations, it will be appreciated that a machine learning model, a digital assistant, and a user profile may be distributed in a computing system in a variety of ways to facilitate personalization of the digital assistant. In the networked-computing environment 100 of FIG. 1 the computing device 102 houses the digital profile 110 and the server 106 houses the learning model 114. In the networked-computing environment 200 of FIG. 2 the server 206 houses the digital profile 210 and the machine learning model 214.

The digital assistant 112, 212 may be accessed by a user to receive input such as a query. For example, the user queries the digital assistant 112, 212 for a list of restaurants that are nearby. The digital assistant may then access an application on the device or resources external to the device to perform the task of generating results such as a list of restaurants nearby. In one or more embodiments, the digital assistant accesses an online source in order to perform a task. For example, the user digital assistant can access a website of one or more vendors over the Internet.

After the digital assistant generates the search results, the user can then select one of the restaurants to call and place an order or drive to the location of one of the restaurants. However, after a period of time such as a few days, weeks or longer, the user may not remember the name of the restaurant or its location which requires the user to initiate the same query again and also the digital assistant to again provide the same or similar results.

Thus, the digital assistant cannot recall not just the list of results that were provided in response to the user's previous queries, the digital assistant also cannot recall which search result the user previously selected. Moreover, although the devices 102 or the server 206 may include a digital profile 110, 210, these profiles 110, 210 traditionally do not include information associated with past queries or past tasks performed by the digital assistants 112, 212. Moreover, the profiles 110, 210 do not include information about the user's interaction with the device, the digital assistant or information provided as a result of accessing applications of the device and external resources.

In one or more embodiments, a knowledge base could be generated that includes information about the user's past inputs to the digital assistant, the tasks the digital assistant then performs, and the user's interactions. For example, a particular query from the user could be linked to a particular task performed by the digital assistant. Also, a user input and a corresponding task completed or performed by the digital assistant could together define a session that is stored in a knowledge base that is accessible to the digital assistant. The knowledge base could store any number of sessions in order to allow the digital assistant to retrieve information about any particular session. For example, a (second) input from a user received by the digital assistant could reference or refer to a previous (first) input. In particular, sometime after a first query and a task performed by the digital assistant of a first session, the digital assistant receives a second query referencing information about the first session such as information related to the first query or the corresponding completed task. The digital assistant can then retrieve from the knowledge base the information about the first session such as the first query, search results provided in response to the first query and/or the user's interactions with the digital assistant that occurred in response to receiving the particular search results to the first query.

In one or more embodiments, each session may be assigned an identifier (ID) which may be utilized by the digital assistant to retrieve information associated with a particular session. In such case, defining a first session includes assigning an ID to the first session and then retrieving information about the first session from the knowledge base includes utilizing the ID of the first information to retrieve the information associated with the first session. In one or more embodiment, the ID may be part of an RTF structure or other structure having an ID.

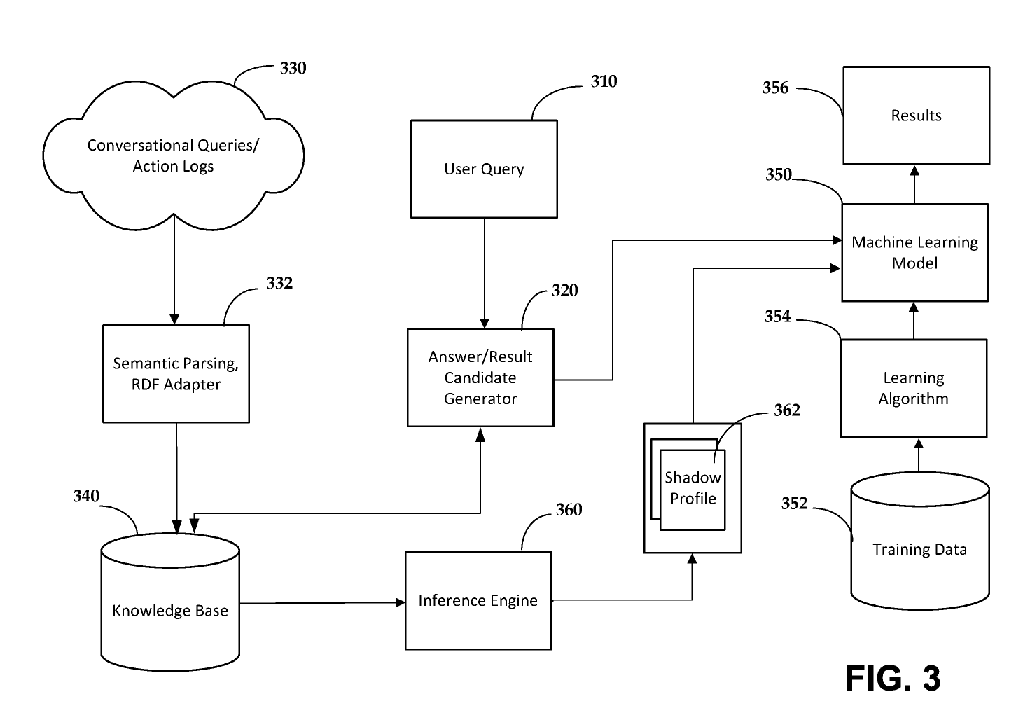

FIG. 3 illustrates the system architecture of a system 300 with the general stages involved in personalizing a digital assistant according to at least one embodiment. In FIG. 3, components having reference numbers 310, 320, 350 and 356 represent runtime components while the remaining components of FIG. 3 represent offline components. As part of the runtime flow, the user query of block 310 is received and then sent to the answer/result candidate generator of block 320. As part of the offline process the past conversational queries and action logs are depicted in cloud 330 and semantic parsing may be performed via an RDF adapter as shown in block 332. Thus, the user's past conversations along with the digital assistant's actions and the user's interactions to the digital assistant are used to build the knowledge base 340.

Referring again to the runtime flow, the candidate generator of block 320 makes a call to the knowledge base 340 which returns to the candidate generator 320 the candidate results. The candidate results are the past conversations of one or more sessions that could be used in the current session based on the current user query which are sent to the machine learning model 350. The machine learning model 350 is trained with the training data 352 via the learning algorithm 354 as understood by those skilled in the art of machine learning models. The machine learning model 350 ranks the results 356 and returns the top result. Thus, the best response retrieved from the knowledge base 340 is provided in response to the user's current query. In one or more embodiments, the model 350 is accessed and trained to identify from the knowledge base 340 the most likely task to perform in response to the user's input.

The machine learning models of FIGS. 1 and 2 may be the machine learning model 350 housed in a server such as servers 106, 206. The machine learning model 350 receives information regarding the user such as information from an indirect question asked by a digital assistant 112. For example, in response to the question “do you want extra cheese on that pizza” a user may have previously responded “yes” to that same question. The response may have been previously received at computing device 102 by the digital assistant 112. The response may then be sent over a network 108 to the server 106 to be processed by the machine learning model.

Processing of information regarding a user by machine learning model 350 includes the machine learning model 350 processing responses to indirect questions to determine what information may be inferred from the response. For example, a machine learning module 350 may have access to information that associates responses to indirect questions. The machine learning model 350 may use statistical modeling to make a prediction based on a user's response to an indirect query.

In addition to determining from the knowledge base 350 which task to perform in response to a user's input/query, inferences may also be determined from the knowledge based 340 without user input/query. The inferences are linked to information such as personal preferences, likes or dislikes, typical user interactions, action taken in the past, within the knowledge base 340. FIG. 3 also illustrates inference engine 360 which generates the inferences from the knowledge base 340 as well as what may be referred to as a shadow profile 362 based on the inferences generated/collected from the knowledge base 340. Thus, the digital assistant may determine which task to perform, in response to user input or not, based on a shadow profile 362. In one or more embodiments, the inferences generated by the inference engine 360 may be based on at least one of: the information from the knowledge base, information from an application on the user's device, interactions with the digital assistant or an application on the user's device, and information provided as a result of the user accessing an external source with the device. In another embodiment, inferencing may connect multiple conversations, events, interactions or activities across multiple sessions. Multiple sessions connected by one or more inferences may be referred to as cross sessions.

A software application such as a bot may run automated tasks or scripts which can retrieve information. In at least one embodiment, an alter ego bot of a user can perform an action on the user's behalf without requiring an actual conversation. In other words, a bot could be the user's digital assistant. The bot can also utilize information of the sessions from the knowledge base and the shadow profile in order to perform a task on the user's behalf. For example, when the digit assistant is placing an order in response to a user input, a query may be received from a live person or from a vendor's bot. The query from the bot may be something like “Do you want any toppings on that pizza?” Then in such case, the response to the vendor's bot derived from the knowledge base or the shadow profile could be, for example, “No, I never add toppings to the pizza.” Also, for example, the vendor's bot could ask “Where do you want it delivered?” Then the response derived from either the knowledge base or the shadow profile could be the user's physical address. The bot also could add to the information of the knowledge base or the shadow profile. Thus, the bot or digital assistant captures, retrieves and reasons over previous actions and information.

The shadow profile 362 may be the same as or part of the digital profiles 110, 210 of FIGS. 1 and 2, or the shadow profile 362 may be generated in place of or in addition to the digital profiles 110, 210.

The knowledge base 310 may be modeled as a set of assertions. Each assertion a is a triple of the form {e_{sbj}^{id}, p, e_{obj}^{id}} where p denotes a predicate, e_{sbj}^{id} and e_{obj}^{id} denote the subject and the object entities of a, with unique IDs (id). The task completion platform (TCP) runtime task frame is used for instantiating the assertion triples. The task frame parameters P represent the predicates, with each task frame instance as the subject entity, e_{sbj}^{id} and resolved parameter values correspond to the object entity e_{obj}^{id}. Aspects of this were a focus of U.S. patent application Ser. No. 14/704,564, filed May 5, 2015, entitled “Building Multimodal Collaborative Dialogs with Task Frames,” and U.S. patent application Ser. No. 14/797,444, filed Jul. 13, 2015, entitled “Task State Tracking in Systems and Services” which are incorporated herein by reference in their entireties.

As an example consider a user task to “remind me about buying milk at 10 am on Friday” with a simplified task frame as:

{

“TaskLifeTimeGUID”:“6b5b525b-3c8b-4653-a1ef-0a570bbea285”,
“TurnIndex”:3,
“Parameters”:[

[

{

“Name”:“ReminderText”,
“Value”:“buy milk”,
“State”:1,
“DialogEntityGUID”:“f41a4f3c-96e9-4cf7-a917-66b2c18b451a”

},
{

“Name”:“TimeTrigger”,
“Value”:“20160101T-530”,
“State”:1,
“DialogEntityGUID”:“88c7c6c8-bb48-4e0d-8eb4-fbad062ea84e”

},
{

“Name”:“Final Action”,
“Value”:“calander event”,
“State”:1,
“DialogEntityGUID”:“460fa4e2-7f96-46bc-ace4-dada93afac82”

}

]

]

}

This results in knowledge base assertions as:

a₁: {e¹, Reminder, e [symbol] }

a₂: {e [symbol] , Reminder.ReminderText, e [symbol] }

a₃: {e [symbol] , Reminder.TimeTrigger, e [symbol] }

a₄: {e [symbol] , Reminder.FinalAction, e [symbol] }

a₅: {e [symbol] , Entity.Value, “buymilk”}

a₆: {e [symbol] , Entity.Type, “string”}

a₇: {e [symbol] , Entity.State, “Resolved”}

a₈: {e [symbol] , Entity.Value, “20160101T-530”}

. . .

. . .

Search queries which are not handled by the TCP platform are transformed to assertions with predicate as “Query.Search” and object as the user search query.

a₁₁: {e [symbol] ,Query.Search, e [symbol] }

a₁₂: {e [symbol] ,Entity.Value, “mexican restaurants near me”}

a₁₃: {e [symbol] , Domain, “restaurant”}

a₁₄: {e [symbol] , Query.Search.ClickedResult, e [symbol] }

a₁₅: {e [symbol] , Local.Cuisine, “mexican”}

. . .

. . .

This approach builds a true semantic graph over user tasks and search queries connecting the user's past conversational actions with the semantic web. The graph formalism allows the platform to embed meta information like query time and location seamlessly.

The knowledge base 340 is sampled to build the training set of data 352 and the machine learning model 350 retrieves the relevant information/response. There are tools targeting question answering problems available in the literature varying from Information Retrieval based approaches in recent past to use of layered end-to-end trainable artificial neural networks more recently.

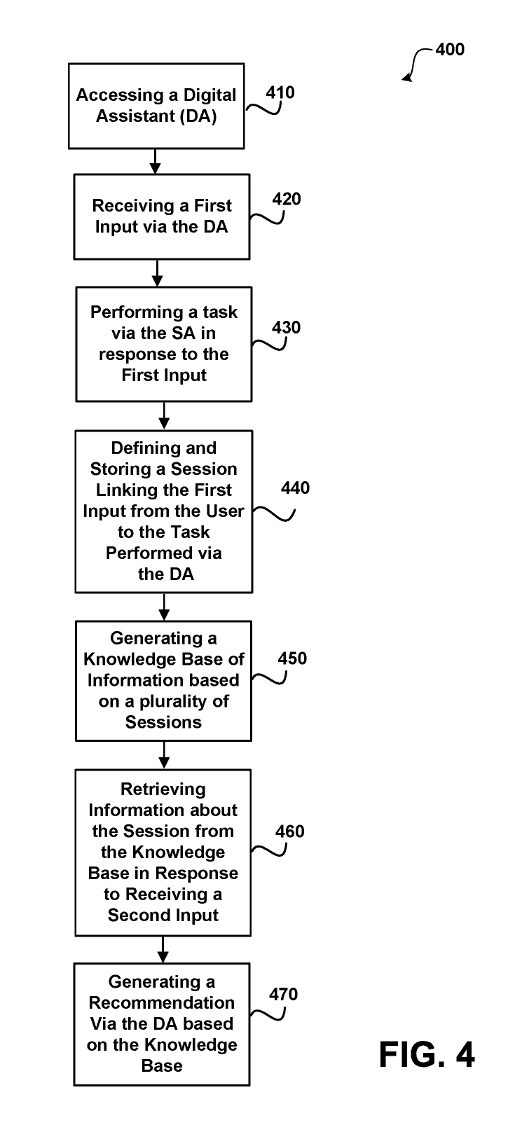

FIG. 4 illustrates a flowchart for a process 400 for enhancing a digital assistant according to at least one embodiment. The process 400 includes process block 410 for accessing a digital assistant with a computing device and process block 420 for receiving a first input from the user via the digital assistant. In process block 430 the digital assistant performs a task in response to the first input. For example, the digital assistant provides search results in response to a query from the user. In process block 440 a first session is defined and stored which links the first input from the user with the completed task that was performed by the digital assistant. For example, a session is generated and stored that links the user's query with the search results generated and provided by the digital assistant. The process 400 also includes process block 450 for generating a knowledge base of information associated with a plurality of sessions. For example, a knowledge base can be generated that stores the session linking the user's query with the search results generated and provided by the digital assistant.

The process 400 may also include the process block 460 for retrieving information about the first session from the knowledge base in response to subsequently receiving a second input from the user. For example, in response to a second query received from the user during a second session, the digital assistant may retrieve or recall information from the knowledge base about a prior first session linking a first query with the digital assistants corresponding completed task. The process 400 may also include the process block 470 for generating a recommendation via the digital assistant to the user based on information in the knowledge base. Generating of recommendations to the user based on information in the knowledge base could occur without prompting by the user in response to the digital assistant learning information from the knowledge base or the shadow profile. Generating of recommendations to the user based on information in the knowledge base or the shadow profile could also occur in response to the digital assistant determining a current status of the user such as the user's current location and/or a particular time. For example, the digital assistant could learn from the knowledge base or the shadow profile that the user previously ordered or dined at a particular location in close proximity to the user's current location. It is to be understood that additional operations may be performed between the process steps described here or in addition to those steps.

Embodiments, for example, are described above with reference to block diagrams and/or operational illustrations of methods, systems, and computer program products according to embodiments. The functions/acts noted in the blocks may occur out of the order as shown in any flowchart or described herein with reference to the Figures. For example, two steps or processes shown or described in succession may in fact be executed substantially concurrently or the blocks may sometimes be executed in the reverse order, depending upon the functionality/acts involved.

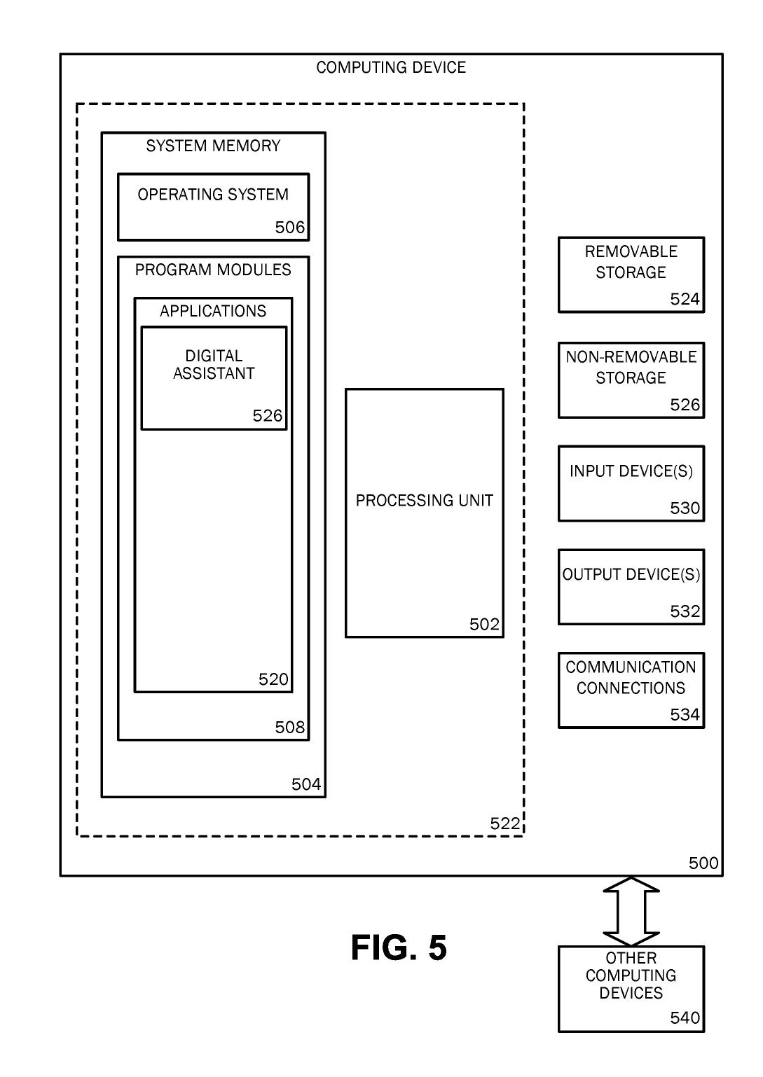

FIGS. 5, 6A, 6B and 7 and the associated descriptions provide a discussion of a variety of operating environments in which embodiments of the invention may be practiced. However, the devices and systems illustrated and discussed with respect to FIGS. 5, 6A, 6B and 7 are for purposes of example and illustration and are not limiting of a vast number of computing device configurations that may be utilized for practicing embodiments of the invention, described herein.

FIG. 5 is a block diagram illustrating physical components (i.e., hardware) of a computing device 500 with which embodiments of the invention may be practiced. The computing device components described below may be suitable for the computing devices described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 506 and one or more program modules 508 suitable for running software applications 520 such as digital assistant 526. The operating system 506, for example, may be suitable for controlling the operation of the computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 522. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 524 and a non-removable storage device 526.

As stated above, a number of program modules and data files may be stored in the system memory 504. While executing on the processing unit 502, the program modules 508 may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 530 such as a keyboard, a mouse, a pen, a sound input device, a touch input device, etc. The output device(s) 532 such as a display, speakers, a printer, etc. may also be included. The aforementioned devices are examples and others may be used. The computing device 500 may include one or more communication connections 534 allowing communications with other computing devices 540. Examples of suitable communication connections 534 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 524, and the non-removable storage device 526 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

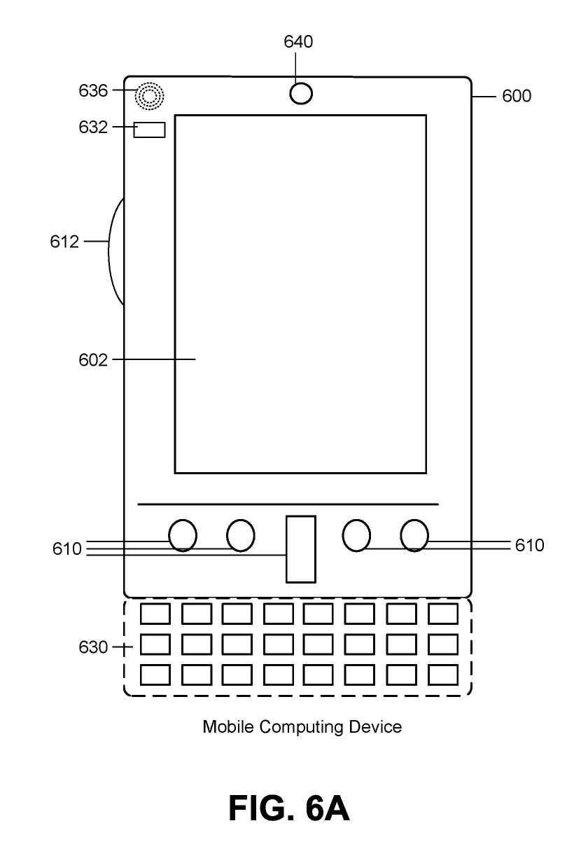

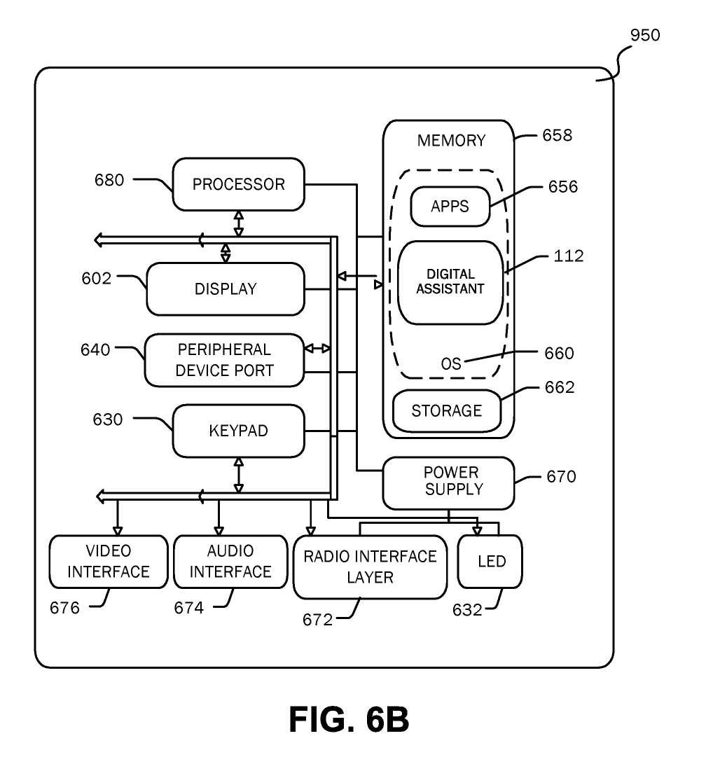

FIGS. 6A and 6B illustrate a mobile computing device 600, for example, a mobile telephone, a smart phone, a tablet personal computer, a laptop computer, and the like, with which embodiments of the invention may be practiced. With reference to FIG. 6A, one embodiment of a mobile computing device 600 for implementing the embodiments is illustrated. In a basic configuration, the mobile computing device 600 is a handheld computer having both input elements and output elements. The mobile computing device 600 typically includes a display 602 and one or more input buttons 610 that allow the user to enter information into the mobile computing device 600. The display 602 of the mobile computing device 600 may also function as an input device (e.g., a touch screen display). If included, an optional side input element 612 allows further user input. The side input element 612 may be a rotary switch, a button, or any other type of manual input element. In alternative embodiments, mobile computing device 600 may incorporate more or less input elements. For example, the display 602 may not be a touch screen in some embodiments. In yet another alternative embodiment, the mobile computing device 600 is a portable phone system, such as a cellular phone. The mobile computing device 600 may also include an optional keypad 630. Optional keypad 630 may be a physical keypad or a “soft” keypad generated on the touch screen display. In various embodiments, the output elements include the display 602 for showing a graphical user interface (GUI), a visual indicator 632 (e.g., a light emitting diode), and/or an audio transducer 636 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system 650 (i.e., an architecture) to implement some embodiments. In one embodiment, the system 650 is implemented as a “smart phone” capable of running one or more applications (e.g., browser, e-mail, calendaring, contact managers, messaging clients, games, and media clients/players). In some embodiments, the system 650 is integrated as a computing device, such as an integrated personal digital assistant (PDA) and wireless phone.

One or more application programs 656 may be loaded into the memory 658 and run on or in association with the operating system 660. Examples of the application programs include digital assistants, phone dialer programs, e-mail programs, personal information management (PIM) programs, word processing programs, spreadsheet programs, Internet browser programs, messaging programs, and so forth. The system 650 also includes a non-volatile storage area 662 within the memory 658. The non-volatile storage area 662 may be used to store persistent information that should not be lost if the system 650 is powered down. The application programs 656 may use and store information in the non-volatile storage area 662, such as e-mail or other messages used by an e-mail application, and the like. A synchronization application (not shown) also resides on the system 650 and is programmed to interact with a corresponding synchronization application resident on a host computer to keep the information stored in the non-volatile storage area 662 synchronized with corresponding information stored at the host computer. As should be appreciated, other applications may be loaded into the memory 658 and run on the mobile computing device 600.

The system 650 has a power supply 670, which may be implemented as one or more batteries. The power supply 670 might further include an external power source, such as an AC adapter or a powered docking cradle that supplements or recharges the batteries. The system 650 may also include a radio 672 that performs the function of transmitting and receiving radio frequency communications. The radio 672 facilitates wireless connectivity between the system 650 and the “outside world,” via a communications carrier or service provider. Transmissions to and from the radio 672 are conducted under control of the operating system 660. In other words, communications received by the radio 672 may be disseminated to the application programs 656 via the operating system 660, and vice versa.

The visual indicator 632 may be used to provide visual notifications, and/or an audio interface 674 may be used for producing audible notifications via the audio transducer 636. In the illustrated embodiment, the visual indicator 632 is a light emitting diode (LED) and the audio transducer 636 is a speaker. These devices may be directly coupled to the power supply 670 so that when activated, they remain on for a duration dictated by the notification mechanism even though the processor 680 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 636, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 650 may further include a video interface 682 that enables an operation of an on-board camera to record still images, video stream, and the like.

A mobile computing device 600 implementing the system 650 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 662. Mobile computing device 600 may also include peripheral device port 640.

Data/information generated or captured by the mobile computing device 600 and stored via the system 650 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

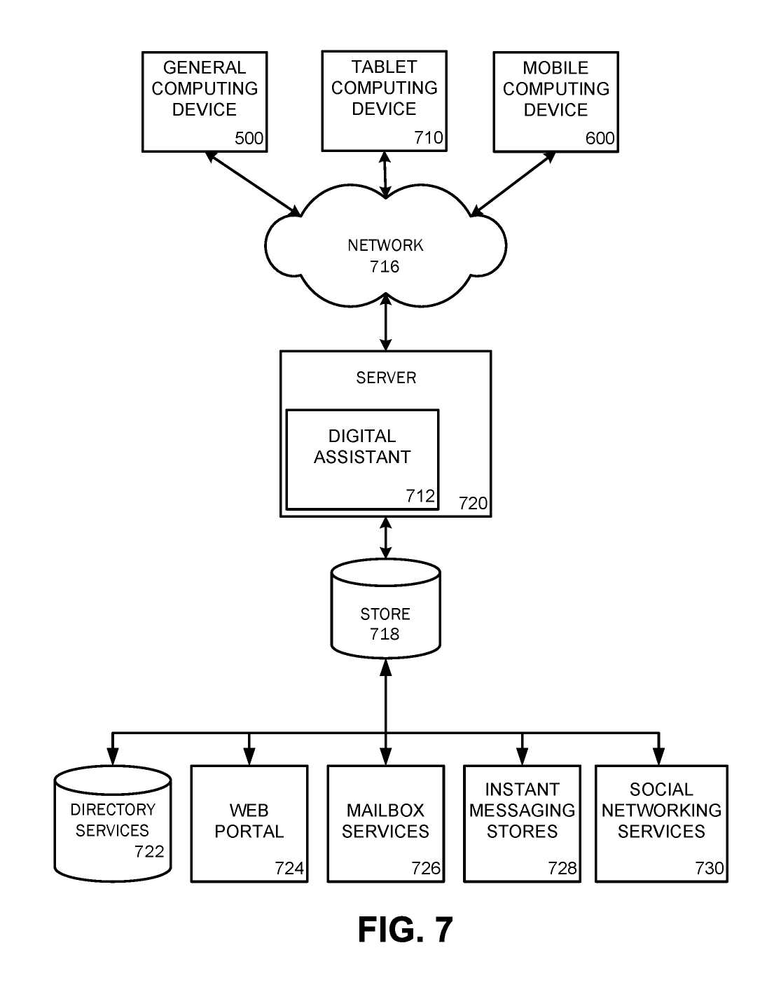

FIG. 7 illustrates an embodiment of an architecture of an exemplary system. Content developed, interacted with, or edited may be stored in different communication channels or other storage types. For example, various documents may be stored using a directory service 722, a web portal 724, a mailbox service 726, an instant messaging store 728, or a social networking site. Any of these types of systems or the like may be used for enabling data utilization. A server 720 may provide the digital assistant 712 to client devices. As one example, the server 720 may be a web server providing the digital assistant over the web. The server 720 may provide the digital assistant over the web to clients through a network 716. By way of example, the client computing device may be implemented as the computing device 500 and embodied in a personal computer, a tablet computing device 710 and/or a mobile computing device 600 (e.g., a smart phone). Any of these embodiments of the client computing device 500, 600, 710 may obtain content from the store 718.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for personalizing a user's digital assistant, comprising:
accessing the digital assistant via a device;
receiving a first input from the user via the digital assistant;
performing a task via the digital assistant in response to the first input;
defining and storing a first session linking the first input from the user with the completed task performed via the digital assistant; and
generating a knowledge base of information associated with a plurality of sessions.

2. The method of claim 1 further comprising retrieving information about the first session from the knowledge base in response to subsequently receiving a second input from the user.

3. The method of claim 2 wherein receiving a second input comprises receiving a query from the user referencing information associated with the first session.

4. The method of claim 2 wherein receiving the first input comprises receiving a first query from the user, performing the task via the digital assistant comprises generating search results in response to the user's first query, and retrieving information about the first session from the knowledge base in response to receiving a second input from the user comprises retrieving information about the first session from the knowledge base.

5. The method of claim 2 wherein receiving the first and second inputs from the user comprises receiving first and second queries, and wherein the second query requests information related to the first query.

6. The method of claim 2 wherein defining the first session comprises assigning an ID to the first session and wherein retrieving information about the first session from the knowledge base comprises utilizing the ID in order to retrieve the information.

7. The method of claim 1 further comprising, wherein in response to receiving a second input from the user during a second session, recalling information associated with the previous first session from the knowledge base in order for the digital assistant to perform a task in response to the user's second input.

8. The method of claim 1 further comprising the digital assistant generating a recommendation to the user based on information in the knowledge base.

9. The method of claim 8 wherein generating the recommendation to the user based on information in the knowledge base occurs without prompting by the user.

10. The method of claim 8 wherein generating the recommendation to the user based on information in the knowledge base occurs in response to the digital assistant determining a status of the user. (ie a location or something or a particular time)

11. The method of claim 1 wherein receiving the first input from the user comprises receiving a voice query and the digital assistant performing the task comprises providing an audible response to the voice query, thereby defining a conversation between the user and the digital assistant.

12. The method of claim 1 further comprising accessing an application on the device in order to perform the task.

13. The method of claim 12 wherein accessing the application on the device in order to perform the task comprises accessing the applications to provide search results in response to the first query from the user.

14. The method of claim 1 further comprising accessing an online source in order to perform the task.

15. The method of claim 1 further comprising accessing a learning model the most likely task to perform in response to the user's first input.

16. The method of claim 1 further comprising generating an inference of a personal preference of the user and a shadow profile based on at least one generated inference, wherein the task is performed by the digital assistant based on the shadow profile.

17. The method of claim 16 wherein generating the inference of the personal preference of the user is based on at least one of:
the information from the knowledge base;
information from an application on the user's device;
interactions with an application on the user's device; and
information provided as a result of the user accessing an external source with the device.

18. A system for enhancing a digital assistant, comprising:
at least one processor; and
an operating environment executing using the at least one processor to perform actions comprising:
receiving a first input from the user via a digital assistant;
performing a task via the digital assistant in response to the user input;
defining and storing a session linking the first input from the user with the completed task performed via the digital assistant; and
generating a knowledge base of information based on a plurality of sessions.

19. The system of claim 18 further comprising retrieving information about the session from the knowledge base in response to subsequently receiving a second input from the user referencing information associated with the session of the first input.

20. A computer-readable storage medium including instructions for enhancing a digital assistant on a user's device, which when executed by a processor are operable to:
accessing the digital assistant via a device;
receiving a first query as input from the user via the digital assistant;
in response to the user's first query, generating search results via the digital assistant accessing an application on the device or accessing an online resource;
defining and storing a session linking the first query from the user with the search results generated via the digital assistant;
generating a knowledge base of information based on a plurality of sessions; and
retrieving information about the session from the knowledge base in response to subsequently receiving a second query as input from the user, wherein the second query references the first query.
